(19) United States
(12) Patent Application Publication
(10) Pub. No.: US 2015/0274409 A1
(43) Pub. Date: Oct. 1, 2015

(54) CONTAINER FOR RECEIVING AND SPLITTING PRODUCT PLATES ALONG WEAKENING GROOVES, USE OF SAID CONTAINER FOR RECEIVING AND SPLITTING PRODUCT PLATES, A PROCESS FOR SPLITTING PRODUCT PLATES, AND PRODUCT PLATES, IN PARTICULAR CHOCOLATE BARS

(71) Applicants: Josef Nachbagauer, Hallein (AT); Matthias Rinderer, Fuschl am See (AT); Lydia Geohler, Salzburg (AT)

(72) Inventors: Josef Nachbagauer, Hallein (AT); Matthias Rinderer, Fuschl am See (AT); Lydia Geohler, Salzburg (AT)

(21) Appl. No.: 14/430,504

(22) PCT Filed: Sep. 24, 2012
(86) PCT No.: PCT/EP2012/003986

§ 371 Date: Mar. 23, 2015

(51) Int. Cl. B65D 85/60; A23G 7/00; A23G 1/00; B65D 51/24; A23G 1/50

(52) U.S. Cl. CPC B65D 85/60; B65D 51/24; A23G 1/50; A23G 1/005; A23G 7/0018; A23V 2002/00

(57) ABSTRACT

Filled container (24) for receiving and splitting at least a single product plate (2), in particular a chocolate bar, containing at least one weakening groove (4) said product plate is adapted to be separated along said weakening groove or weakening grooves into separate pieces; said container having a longitudinal axis; wherein said container can be transferred from a closed, first position into an opened, second position; said container comprising an upper part (26) comprising a container lid (30) and, connected to said container lid, a first side wall (32) having a first rim; and a corresponding lower part (28) comprising a container bottom and, connected to said container bottom, a second side wall having a second rim; at least a single product plate, inside said container, said single product plate having at least one weakening groove, in particular a multitude of weakening grooves, so that upon deflecting said container lid in the direction of the interior of said container, and/or that upon deflecting said container bottom in the direction of the interior of said container at least one product plate is separated into individual pieces along at least one, in particular essentially all of the weakening grooves. The invention further refers to the use of said container for receiving and splitting product plates, in particular of chocolate bars, along weakening grooves, to a process for splitting product plates, in particular chocolate bars, along weakening grooves as well as to product plates, in particular chocolate bars, and stacks comprising said product plates.

The present invention refers to a container for receiving and splitting product plates, in particular chocolate bars, along weakening grooves, use of a container for receiving and splitting product plates, in particular of chocolate bars, along weakening grooves, a process for splitting product plates, in particular chocolate bars, along weakening grooves and product plates, in particular chocolate bars.

Confectionery such as chocolate is frequently provided in the form of product plates which need to be broken into individual pieces for consumption. Quite often these products have a rather greasy skin or paste-like consistency in particular at higher temperatures, for example when held between fingers tips for a longer period of time. As a consequence, the fingers of the user become dirty and need to be cleaned in order to avoid affecting as well clothes or other objects, in particular when such chocolate bars need to be broken into individual pieces. As precautionary measure such product plates are usually safely packed in, for example, an extra plastic or aluminium sheet. This, however, requires apart from additional material needed for packaging also another packaging step. Moreover, if product plates are broken when still kept in such flexible plastic sheet or aluminium foil there is the risk of crumbs being formed when separating the product plates into individual pieces which will fall out of the opened package and spoil the clothes of the user and/or the floor.

It has therefore been an object of the present invention to provide means for safely storing and transporting product plates which can be separated into individual pieces without the risk of staining or soiling the user.

The problem underlying the present invention has been solved by a filled container, in particular a box, for receiving and splitting a single product plate, in particular a chocolate bar, containing at least one weakening groove or a multitude of product plates, in particular a multitude of chocolate bars, at least one containing at least one weakening groove, said multitude of product plates being arranged in a stack, said product plate or plates are adapted to be separated along said weakening groove or weakening grooves into separate pieces;

said container having a longitudinal axis;
wherein said container can be transferred from a closed, first position into an opened, second position;
said container comprising
an upper part comprising a container lid and, connected to said container lid, a first side wall having a first rim; and
a corresponding lower part comprising a container bottom and, connected to said container bottom, a second side wall having a second rim;
a single product plate, inside said container, with an upper side and an opposite bottom side, said single product plate having, in particular provided at its upper side, at least one, in particular straight, weakening groove, in particular a multitude of weakening grooves, or, in particular,
a multitude of product plates, inside said container, each having an upper side and an opposite bottom side, arranged in a stack, said product plates having, in particular provided at their upper sides, at least one, in particular straight, weakening groove, in particular a multitude of weakening grooves;
wherein the upper side of said single product plate is directed towards the container lid and wherein the bottom side of said single product plate is directed towards the container bottom,
or wherein the upper side of said upper product plate or wherein the upper side of all product plates of the stack of product plates is/are directed towards the container lid and wherein the bottom side of the lowest product plate or the bottom side of all product plates of said stack is/are directed towards the container bottom;
optionally at least one first protective layer between adjacent product plates of said stack and/or at least one second protective layer between the container lid and the upper side of said single product plate or between the container lid and the upper side of the upper product plate of said stack and/or at least one third protective layer between the bottom side of said single product plate and the container bottom or between the bottom side of the lowest product plate in said stack and said container bottom;
wherein said single product plate or said multitude of product plates are separable into individual pieces along said weakening grooves;
wherein said upper part of the container is arranged and adapted, in particular with regard to form, thickness, and/or material, in such a manner that its container lid can be pressed when the container is in the closed position at least at one first operating area, in particular along the longitudinal axis of said container, in the direction of the interior of said container to an extent of at least a first deflection range comprising a first deflection maximum, in particular in a reversible manner, and/or
wherein said lower part of the container is arranged and adapted, in particular with regard to form, thickness and/or material, in such a manner that its container bottom can be pressed when the container is in the closed position at least at one second operating area, in particular along the longitudinal axis of said container, in the direction of the interior of said container to an extent of at least a second deflection range comprising a second deflection maximum, in particular in a reversible manner;
wherein the distance between the container lid, in particular said first operating area, in the closed position of the container and the upper side of the single product plate or the distance between the container lid, in particular said first operating area, in the closed position of the container and the upper side of said upper product plate of said stack or the distance between the container lid, in particular said first operating area, in the closed position of the container and said second protective layer is smaller than said first deflection range or said first deflection maximum, in particular when the single product plate or the stack of product plates is resting on said container bottom or on said third protective layer, and/or
wherein the distance between the container bottom, in particular between said second operating area, in the closed position of the container and the bottom side of the single product plate or the distance between the container bottom, in particular said second operating area, in the closed position of the container and the bottom side of the lowest product plate of said stack or the distance between the container bottom, in particular said second operating area, in the closed position of the container and said third protective layer is smaller than said second deflection range or said second deflection maximum, in particular when the single product plate or the stack of product plates is resting on said container lid or on said second protective layer,
and/or wherein
the sum of the distance between the container bottom, in particular between said second operating area, in the closed position of the container and the bottom side of the single product plate or the distance between the container bottom, in particular said second operating area, in the closed position of the container and the bottom side of the lowest product plate of said stack or the distance between the container bottom, in particular said second operating area, in the closed position of the container and said third protective layer and the distance between the container lid, in particular said first operating area, in the closed position of the container and the upper side of the single product plate or the distance between the container lid, in particular said first operating area, in the closed position of the container and the upper side of said upper product plate of said stack or the distance between the container lid, in particular said first operating area, in the closed position of the container and said second protective layer is smaller than the sum of said first and second deflection ranges or of the sum of said first and second deflection maxima, so that upon deflecting said container lid, in particular said first operating area, in the direction of the interior of said container, in particular along its longitudinal axis, and/or that upon deflecting said container bottom, in particular said second operating area, in the direction of the interior of said container, in particular along its longitudinal axis, at least one product plate, in particular all product plates, are separable or separated into individual pieces along at least one, in particular essentially all of the weakening grooves.

The container of the present invention can, for example, represent a so-called clic-clac box comprising a single product plate or a multitude of product plates arranged in stack.

In one embodiment of the invention the upper part of said container, in particular said container lid, and/or the lower part of said container, in particular said container bottom, comprises or is made of plastic and/or metal, in particular plastic and/or metal sheets. Plastic or metal sheets are usually provided with a certain degree of resiliency and can, thus, be deflected upon application of force on the said sheets.

Said single product plates or said multitude of product plates arranged in stack of, for example, two or three or more product plates, represent in one embodiment edible product plates such as chocolate bars. Product plates in the meaning of the present invention can also encompass, for example, those made of starch, lard, lighter, e.g. charcoal lighter, confectionary, or soap.

In a useful embodiment of the present invention at least two, in particular all, product plates are essentially identical in terms of length and/or width and/or diameter and/or thickness.

The stack of product plates usually is arranged in a manner that all product plates are placed exactly on top of each other so that if all product plates have the same size and shape there is no excess length.

Another useful embodiment of the present invention also provides that at least two, in particular all, product plates exhibit essentially identical weakening grooves with respect to cross-sectional shape and/or length and/or pattern of arrangement. Weakening grooves are in one embodiment of the present invention embedded in the upper side of the product plates. In this manner in stack of product plates weakening grooves are regularly not facing towards each other.

In a practicable mode of carrying out of the present invention the product plates exhibit an essentially polygonal, e.g. rectangular or square basic form, or a circular or oval basic form.

Those containers of the present invention are preferred in which at least two, in particular all weakening grooves have at least one crossing point, in particular in the center of the basic form of the product plates, or that all weakening grooves cross each other in one, in particular central, crossing area of the basic form.

With another useful embodiment of the container of the present invention it is provided that said first side wall and/or said first rim comprise or represent a first holding means and/or that said second side wall and/or said second rim comprise or represent a second holding means.

Those containers of the present invention have been found to be advantageous in which the upper part of the container closes the container in said first position and unblocks said container in said second position, wherein in said first position said first side wall and/or said first rim and/or said first holding means exhibits a form closure with said lower part of the container, in particular with said second side wall and/or said second rim and/or said second holding means,

that said upper part of the container can be transferred from said first to said second position upon a first deflection, in particular of said first operating area, in the direction of the interior of said container, in particular along its longitudinal axis, so that said form closure is, in particular reversibly, released,
and/or that the lower part of the container closes said container in a first position and unblocks said container in said second position, wherein in said first position said second side wall and/or said second rim and/or said second holding means exhibit a form closure with said upper part of the container, in particular with its first side wall and/or first rim and/or said first holding means, and that said lower part of the container can be transferred from said first into said second position upon a second deflection, in particular of said second operating area, in the direction of the interior of said container, in particular along its longitudinal axis, so that the form closure is, in particular reversibly, released.

This embodiment of the container of the present invention is usually also known as an example of a so-called clic-clac box. However, this clic-clac box may have a variety of different designs. However, the containers of the present invention having said characteristics of a clic-clac box are preferably suited.

According to another embodiment of the invention a container is provided in which said first operating area represents or comprises the central part of the container lid and/or that said second operating area represents or comprises the central part of the bottom of the container.

According to a particularly practical embodiment of the container of the present invention it is provided that said first deflection extends over, i.e. lies within, at least said first deflection range and/or that said second deflection extends at least over, i.e. lies within, said second deflection range. Although being also possible it is not necessary that said first deflection has to extend beyond said first deflection range and/or that said second deflection has to extend beyond said second deflection range. As long as said first or second deflection lie within said first and second deflection ranges, respectively, it is safeguarded that the product plate or plates can be separated into individual pieces along said weakening lines. Thus, in this regard it is also preferred that upon deflecting said container lid, in particular said first operating area, in the direction of the interior of said container, in particular along its longitudinal axis, over said first deflection range, in particular up to said first deflection maximum,

or
that upon deflecting said container bottom, in particular said second operating area, in the direction of the interior of said container, in particular along its longitudinal axis, over said second deflection rang, in particular up to said second deflection maximum, or that upon deflecting said container lid, in particular said first operating area, in the direction of the interior of said container, in particular along its longitudinal axis, over said first deflection range, in particular up to said first deflection maximum, and that upon deflecting said container bottom, in particular said second operating area, in the direction of the interior of said container, in particular along its longitudinal axis, over said second deflection rang, in particular up to said second deflection maximum,
at least one product plate, in particular all product plates, are separable or separated into individual pieces along at least one, in particular essentially all of the weakening grooves.

Further, in a very useful embodiment of the present invention said first operating area has at least a partial overlap with the area in which the weakening grooves of one, several or all product plates cross each other, and/or that said second operating area has at least a partial overlap with the area in which the weakening grooves of one, several or all product plates cross each other.

Splitting of product plates, in particular chocolate bars, can be conveniently accomplished with the containers of the present invention if care is taken that the area in which the weakening grooves cross each other have at least a partial overlap with the center of the basic form of the product plates.

This also applies to container of the present invention in which the crossing areas, in particular when located in the central area of the basic form, of the weakening grooves of adjacent product plates, in particular of all product plates, in a stack are essentially arranged in an overlapping manner.

Those containers of the present invention have found to furnish particularly reliable results in which said at least one weakening groove, in particular all weakening grooves, of adjacent, in particular all, product plates in a stack are arranged essentially in overlapping manner.

In the useful embodiment of the present invention it is provided that the basic form of said container and the basic form of the product plates, in particular of said stack of product plates, is essentially identical.

In this regard it is also of advantage when the dimension of the basic form of said product plates, in particular the dimension of the stack of product plates, is, in particular slightly, smaller than the dimension of the basic form of the container.

In one embodiment the weakening grooves of the product plates kept in the container of the present invention are straight-lined and are crossing each other only once, preferably in the center of the basic form of the product plate thereby yielding separable, individual pieces of said product plate which exhibit a triangular-like basic shape or the shape of the segment of a circle, depending on the basic form of the product plate.

It has been also found to be practical to include protective layers between adjacent product plates and/or between a lid in the upper product plate and/or the bottom and the lowest product plate in a stack. In this regard it has been found to be preferable that the first and/or third protective layer, in particular first and third protective layer, represent or comprise a paper sheet and/or that said second and/or said third protective layer, in particular only said second protective layer, represents or comprises a padded or cushioned layer, in particular a paper padded layer.

Another variant of the container of the present invention, in particular in the embodiment of a clic-clac box, is characterized in that upon applying pressure to said first side wall, said first rim and/or said first holding means on opposite sides thereof said first side wall and/or said first rim and/or said first holding means acquire a form closure with the lower part of the container, in particular with its second side wall and/or its second rim and/or its second holding means, thereby transferring the container from the open, second position into the closed, first position.

In order to arrive at an improved interplay between container and product plate or product plates it has been found to be advantageous that the dimension of the basic form of the container and the dimension of the basic form of the single product plate or stack of product plates provide a clearance so that upon deflection of the upper part, in particular of the container lid, and/or the lower part, in particular of the container bottom, lateral movement of the individual pieces split along their weakening grooves is enabled.

Furthermore, suitable containers according to the invention are characterized in that the flanks of said weakening grooves are tilted and are forming on average an angle in the range of 5° to 60°, in particular in the range of 25° to 45°, and more particular in the range of 30° to 40°, and/or that the largest width of the weakening grooves is on average in the range of 3 to 9 millimeter, in particular in the range of 4 to 8 mm, and more preferred in the range of 6 to 7 mm, and/or that the depth of weakening grooves is on average in the range of 2 to 6 mm, in particular in the range of 2.5 to 5 mm, and more preferred in the range of 3 to 4 mm, and/or that the thickness of the product plates is on average in the range of 8 to 20 mm, in particular in the range of 8 to 14 mm, and more preferred in the range of 10.5 to 12 mm, and/or that the diameter of a circular product plate is in the range of 50 to 150 mm, in particular in the range of 60 to 120 mm, and more preferred in the range of 70 to 100 mm.

In a preferred embodiment of a filled container according to the invention the depth of weakening grooves is on average from 10 to 60%, in particular from 20 to 50%, and more preferred from 25 to 45%, of the thickness of the product plate.

Moreover, the object underlying the present invention has also been solved by a process for splitting of product plates, in particular chocolate bars, into individual pieces along weakening grooves in said product plates comprising

providing a container according to the present invention or a clic-clac box, placing a single product plate, in particular a chocolate bar, containing at least one, in particular at least two weakening grooves, or a multitude of product plates, in particular a multitude of chocolate bars, at least one containing at least one, in particular at least two weakening grooves, said multitude of product plates being arranged in a stack, in said container or box,
deflecting the upper part, in particular the lid, of said container or box, in particular in the first operating area, and/or deflecting the lower part, in particular the container bottom, of said container or box, in particular in said second operating area, in such a manner that said upper part of the container or box, in particular the container lid, is deflected in the direction of the interior of said container, in particular along its longitudinal axis, and/or in such a manner that the lower part of said container or box, in particular the container bottom of said container or box, is deflected in the direction of the interior of said container or box, in particular along its longitudinal axis, thereby splitting the product plates into individual pieces along said weakening grooves.

In a preferred embodiment of the process of the present invention it is provided that the distance between the container lid, in particular said first operating area, in the closed position of the container and the upper side of the single product plate or the distance between the container lid, in particular said first operating area, in the closed position of the container and the upper side of said upper product plate of said stack or the distance between the container lid, in particular said first operating area, in the closed position of the container and said second protective layer is smaller than said first deflection range or said first deflection maximum, in particular when the single product plate or the stack of product plates is resting on said container bottom or on said third protective layer, and/or it is provided that the distance between the container bottom, in particular between said second operating area, in the closed position of the container and the bottom side of the single product plate or the distance between the container bottom, in particular said second operating area, in the closed position of the container and the bottom side of the lowest product plate of said stack or the distance between the container bottom, in particular said second operating area, in the closed position of the container and said third protective layer is smaller than said second deflection range or said second deflection maximum, in

particular when the single product plate or the stack of product plates is resting on said container lid or on said second protective layer,
or
it is provided that the sum of the distance between the container bottom, in particular between said second operating area, in the closed position of the container and the bottom side of the single product plate or the distance between the container bottom, in particular said second operating area, in the closed position of the container and the bottom side of the lowest product plate of said stack or the distance between the container bottom, in particular said second operating area, in the closed position of the container and said third protective layer and the distance between the container lid, in particular said first operating area, in the closed position of the container and the upper side of the single product plate or the distance between the container lid, in particular said first operating area, in the closed position of the container and the upper side of said upper product plate of said stack or the distance between the container lid, in particular said first operating area, in the closed position of the container and said second protective layer is smaller than the sum of said first and second deflection ranges or of the sum of said first and second deflection maxima.

It is also preferred in this regard that it is provided that upon deflecting said container lid, in particular said first operating area, in the direction of the interior of said container, in particular along its longitudinal axis, over said first deflection range, in particular up to said first deflection maximum,

or
that upon deflecting said container bottom, in particular said second operating area, in the direction of the interior of said container, in particular along its longitudinal axis, over said second deflection rang, in particular up to said second deflection maximum, or
that upon deflecting said container lid, in particular said first operating area, in the direction of the interior of said container, in particular along its longitudinal axis, over said first deflection range, in particular up to said first deflection maximum, and that upon deflecting said container bottom, in particular said second operating area, in the direction of the interior of said container, in particular along its longitudinal axis, over said second deflection rang, in particular up to said second deflection maximum,
at least one product plate, in particular all product plates, are separated into individual pieces along at least one, in particular essentially all of the weakening grooves.

Further, the problem underlying the present invention has also been solved by a product plate, in particular chocolate bar, which can be split along weakening grooves into individual pieces, comprising a bottom side, a top side and a rim, wherein said bottom side and/or said upper side comprise at least two weakening grooves which extend from a first position of the rim to a second position of said rim wherein said weakening grooves cross each other, in particular only once and/or in the central part of the product plate.

Such product plates are preferred which comprise only one crossing area in which all weakening grooves cross each other.

A reliable splitting of said product plates into individual pieces is in particular accomplished in a very reliable manner when the weakening grooves with regard to their cross-sectional shape extend on average over of at least a third of the average thickness of the product plate. In general, it is preferred when the depth of weakening grooves is on average from 10 to 60%, in particular from 20 to 50%, and more preferred from 25 to 45%, of the thickness of the product plate.

In a very pragmatic embodiment said weakening grooves have a tapered cross-section from top to bottom. Moreover, it has been found to be a rather useful embodiment in which said crossing grooves are essentially straight lined. Generally, the product plate of the invention can have any basic form. But, in particularly useful embodiments of product plates according to the invention the basic form of said product plates is circular, oval or polygonal.

It has also been found that product plates according to the invention in one embodiment are characterized in that the flanks of said weakening grooves are tilted and are forming on average an angle the range of 5 to 60°.

Further, product plates according to the invention can be characterized in that the largest width of the weakening grooves is on average in the range of 3 to 9 millimeter, in particular in the range of 4 to 8 mm, and more preferred in the range of 6 to 7 mm, and/or that the depth of weakening grooves is on average in the range of 2 to 6 mm, in particular in the range of 2.5 to 5 mm, and more preferred in the range of 3 to 4 mm, and/or that the thickness of the product plates is on average in the range of 8 to 20 mm, in particular in the range of 8 to 14 mm, and more preferred in the range of 10.5 to 12 mm, and/or that the diameter of a circular product plate is in the range of 50 to 150 mm, in particular in the range of 60 to 120 mm, and more preferred in the range of 70 to 100 mm.

Particular, results have been obtained also width those product plates according to the invention in which the crossing area of weakening grooves is broader than the width of said weakening grooves.

In one embodiment, also those products plates according to the invention are preferred in which at least one, in particular several or all separable individual pieces of said product plate formed by weakening grooves crossing each other have a smaller thickness adjacent to the crossing area than adjacent to the rim.

Splitting is also accomplished in a very reliable manner with those product plates according to the invention in which at least one, in particular all crossing grooves have a. smaller depth adjacent to the crossing area than adjacent to the rim.

A problem underlying the present invention has also been solved by a stack of product plates comprising at least two product plates according to the invention as outlined above.

The longitudinal axis of the container of the present invention can be understood in the meaning of the present invention to represent said axis which extends from the upper part of the container, in particular the center of the upper part, in particular of the lid, to the lower part of the container, in particular the center of the lower part, in particular of the container bottom.

The filled container of the present invention offers varies advantages of over prior art packages. It not only serves the purpose to safely store and transport separable product plates such as chocolate bars but also enables the user to reliably transfer product plates into separated pieces which automatically have a proper size for consumption even without having opened the container. With the present invention unnecessary formation of crumbs can be reduced or even prevented. And, in case such crumbs will be formed upon splitting up said product plates these crumbs are safely kept in the lower part of the container so that there is no risk of soiling or staining ones clothes upon opening said container.

It has also been surprisingly found that a multitude of product plates such as chocolate bars when arranged in stack can be completely transferred into separate individual pieces by use of the container of the present invention. There is no need at all to touch the product plates with the fingers in order to separate these plates into individual pieces. Moreover, by opening the container that is, by removing a lid a means is provided for offering individual pieces for consumption in an aesthetically pleasing manner. That is, individual pieces are not arranged in an arbitrary manner, but are still well placed within the container. The present invention offers the additional advantage that it is not necessary to prepare small individual pieces and to fill these pieces into respective containers in a rather laborious manner. Instead, product plates can be prepared which can be loaded into said containers, even in the form of stacks, by use of an automatic process. Moreover, with the present invention the handling of single pieces in production and packaging can be circumvented and replaced in the interest of simplicity in production and packaging by product plates such as chocolate bars.

The invention, together with further objects and advantages, may be best understood, for example, with reference to the following description of the following embodiments taken with the accompanying drawings, in which

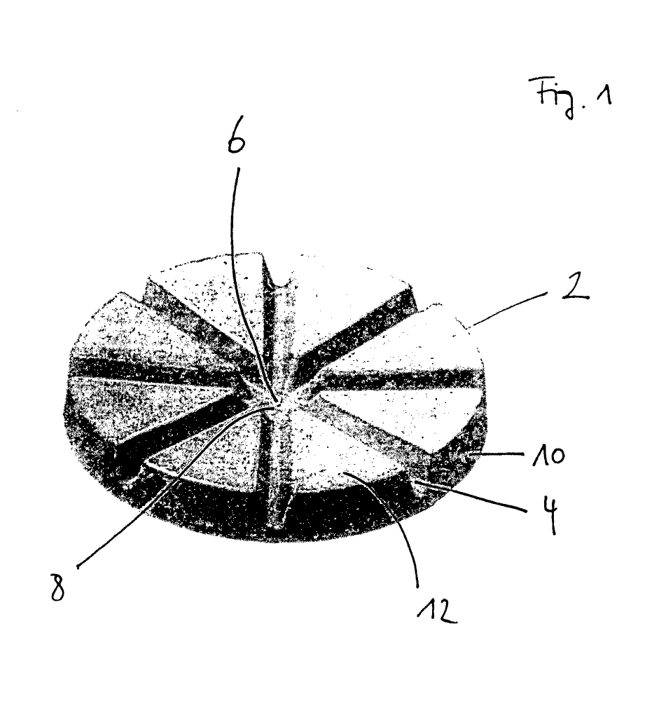

FIG. 1 shows a perspective view of a single chocolate bar according to the invention

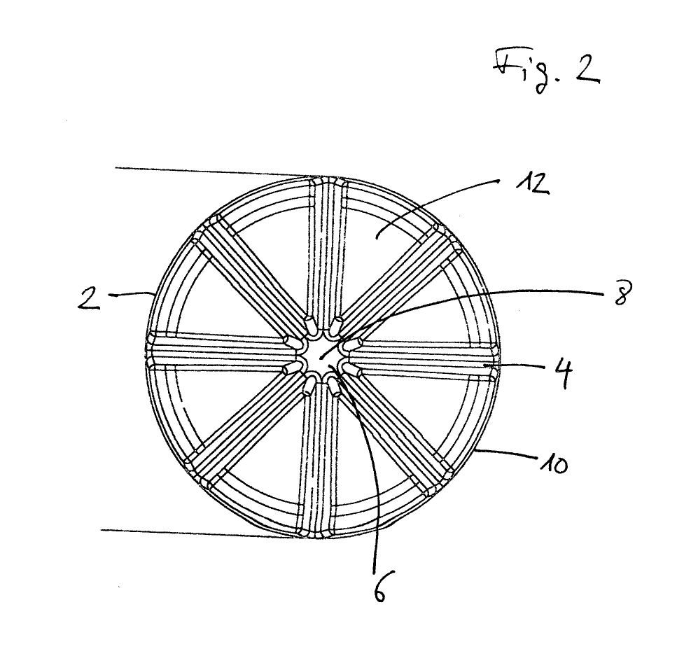

FIG. 2 shows a schematic top plan view of the chocolate bar according to FIG. 1 in a schematic drawing,

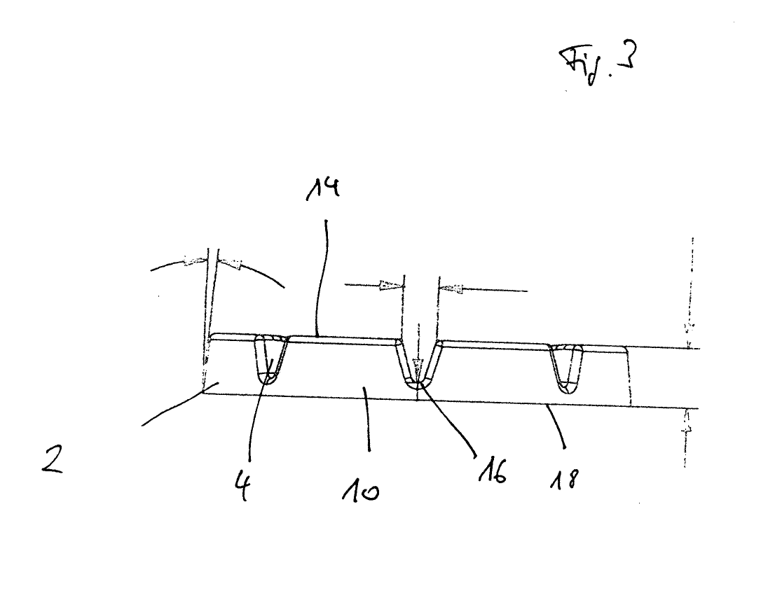

FIG. 3 shows a schematic side view of the chocolate bar according to FIGS. 1 and 2,

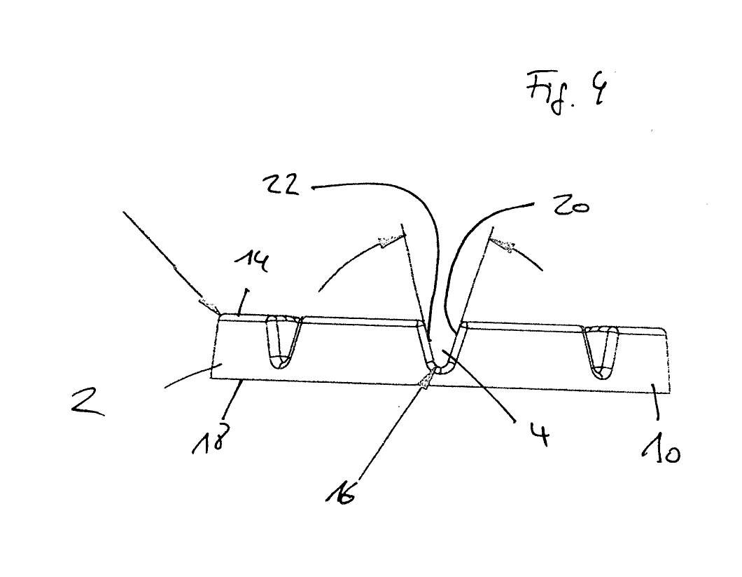

FIG. 4 shows another schematic side view of the chocolate bar according to FIGS. 1 and 2,

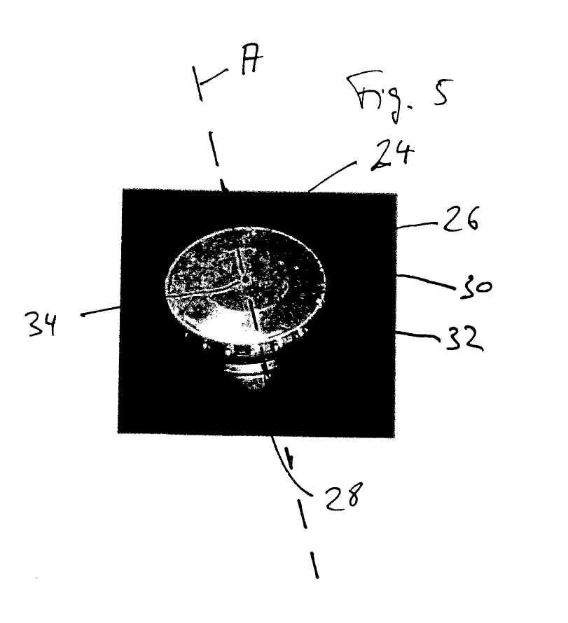

FIG. 5 shows a perspective view of the container of the present invention,

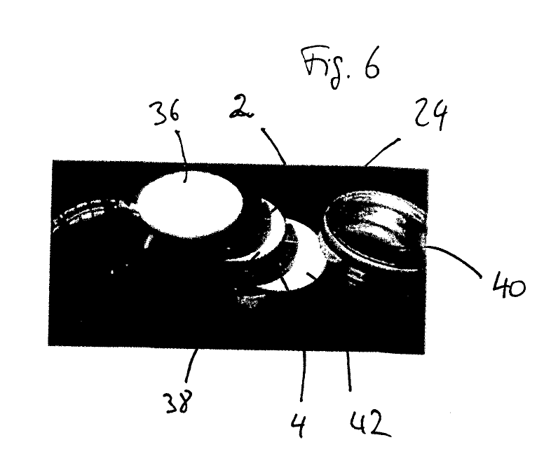

FIG. 6 shows a perspective view of the opened container of the present invention,

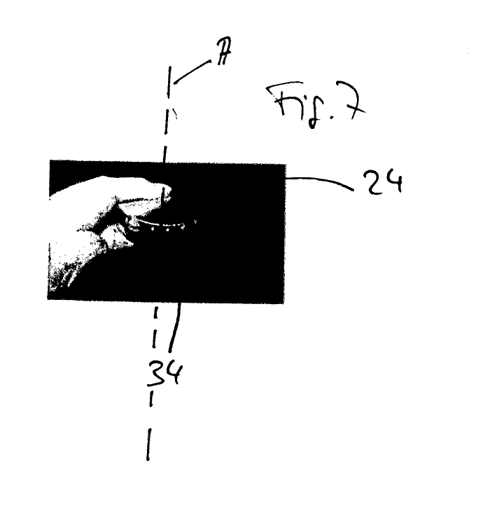

FIG. 7 shows the process step of pressing the container lid of the container of the present invention,

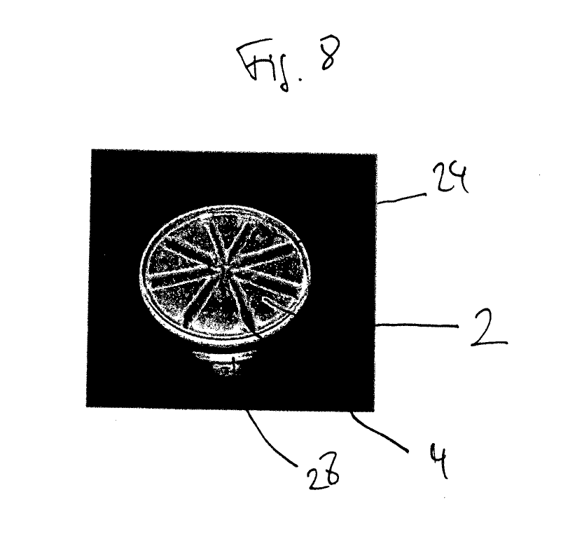

FIG. 8 shows an opened container of the present invention containing undivided chocolate bars, and

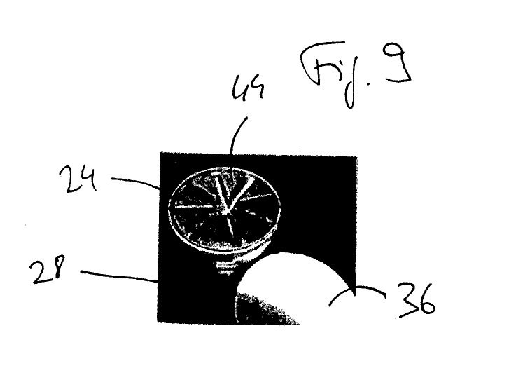

FIG. 9 shows an opened container of the present invention containing chocolate bars having been separated into individual pieces by the process according to the invention.

In FIG. 1 chocolate bar 2 according to the present invention is depicted which has a circular basic form and comprises in total four straight weakening grooves 4 which cross each other and a single crossing area 6 which is overlapping the center 8 of the basic form of the chocolate bar 2. The weakening grooves 4 extend from one side of the rim 10 of the chocolate bar 2 to the opposite rim portion of the chocolate bar. Said crossing weakening grooves 4 are creating segments of a circle 12 which can be separated according to the process of the present invention into individual pieces. With the chocolate bar 2 depicted in FIG. 1 said weakening grooves 4 have an essentially V-shaped cross-section.

FIG. 2 depicts a schematic top plan view of the chocolate bar according to FIG. 1. Weakening grooves 4 have the length of the diameter of the circular basic form of the chocolate bar 2.

In FIG. 3 a schematic side view of the chocolate bar according to FIGS. 1 and 2 is shown. The weakening grooves 4 have their largest width at the upper side 14 of the chocolate bar 2 and the smallest width adjacent to the trough 16. The circumferential rim 10 can be tilted slightly towards the center 8 from lower side 18 to upper side 14. The thickness of the chocolate bar 2 is determined as the range between the upper side 14 and lower side 18.

FIG. 4 is essentially identical to FIG. 3. From FIG. 4 it can be derived that the flanks 20 and 22 of the weakening grooves 4 are slightly tapered outwards and therefore forming an angle.

FIG. 5 shows a container 24 of the present invention in closed position comprising an upper part 26 and lower part 28. The upper part 26 comprises a container lid 30 and rim or side wall 32. FIG. 5 also shows a first operating area 34 in the center of the container lid 30. By use of a dashed line the longitudinal axis A is depicted.

In FIG. 6 the container 24 of the present invention is shown together with product plates 2 in the form of chocolate bars being equipped with weakening grooves 4. In addition on top of the upper chocolate bar 2 a second protective layer 36 is placed, preferably in the form of a padded paper layer. Furthermore, between both chocolate bars 2 a first protective layer 38 in the form of a paper layer is placed, and between the lower chocolate bar 2 and the container bottom 40 a third protective layer 42 is placed.

As can be derived from FIG. 7 upon applying pressure to the first operating area 34 of the container 24 according to the present invention the chocolate bars are split into individual pieces. Simultaneously the upper part 26 of the container is no longer locked to the lower part 28 of the container so that said container can be easily opened and its content offered for consumption. By use of a dashed line the longitudinal axis A is depicted.

FIG. 8 shows the container 24 of the present invention without its upper part 26. That is, the upper part 26 has been removed without pressing the container lid towards the interior of the container so that the chocolate bars 2 placed inside the lower part of the container are still in an undivided state. If pressure is applied to the container lid separated individual pieces 44 result as depicted in FIG. 9.

Although modifications and changes maybe suggested by those skilled in the art, it is the intention of the applicant to embody within the patent warranted hereon all changes and modifications as reasonably and probably come within the scope of this contribution to the art. The features of the present invention which are believed to be novel are set forth in detail in the appended claims. The features disclosed in the description, the figures as well as the claims could be essential alone or in every combination for the realization of the invention in its different embodiments.

1. Filled container, in particular a box, for receiving and splitting a single product plate,
in particular a chocolate bar, containing at least one weakening groove or a multitude of product plates, in particular a multitude of chocolate bars, at least one containing at least one weakening groove, said multitude of product plates being arranged in a stack, said product plate or plates are adapted to be separated along said weakening groove or weakening grooves into separate pieces;
said container having a longitudinal axis;
wherein said container can be transferred from a closed, first position into an opened, second position;
said container comprising
an upper part comprising a container lid and, connected to said container lid, a first side wall having a first rim; and
a corresponding lower part comprising a container bottom and, connected to said container bottom, a second side wall having a second rim;
a single product plate, inside said container, with an upper side and an opposite bottom side, said single product plate having, in particular provided at its upper side, at least one, in particular straight, weakening groove, in particular a multitude of weakening grooves,
or, in particular,
a multitude of product plates, inside said container, each having an upper side and an opposite bottom side, arranged in a stack, said product plates having, in particular provided at their upper sides, at least one, in particular straight, weakening groove, in particular a multitude of weakening grooves;
wherein the upper side of said single product plate is directed towards the container lid and wherein the bottom side of said single product plate is directed towards the container bottom,
or wherein the upper side of said upper product plate or wherein the upper side of all product plates of the stack of product plates is/are directed towards the container lid and wherein the bottom side of the lowest product plate or the bottom side of all product plates of said stack is/are directed towards the container bottom;
optionally at least one first protective layer between adjacent product plates of said stack and/or at least one second protective layer between the container lid and the upper side of said single product plate or between the container lid and the upper side of the upper product plate of said stack and/or at least one third protective layer between the bottom side of said single product plate and the container bottom or between the bottom side of the lowest product plate in said stack and said container bottom;
wherein said single product plate or said multitude of product plates are separable into individual pieces along said weakening grooves;
wherein said upper part of the container is arranged and adapted, in particular with regard to form, thickness, and/or material, in such a manner that its container lid can be pressed when the container is in the closed position at least at one first operating area, in particular along the longitudinal axis of said container, in the direction of the interior of said container to an extent of at least a first deflection range comprising a first deflection maximum, in particular in a reversible manner, and/or
wherein said lower part of the container is arranged and adapted, in particular with regard to form, thickness and/or material, in such a manner that its container bottom can be pressed when the container is in the closed position at least at one second operating area, in particular along the longitudinal axis of said container, in the direction of the interior of said container to an extent of at least a second deflection range comprising a second deflection maximum, in particular in a reversible manner;
wherein the distance between the container lid, in particular said first operating area, in the closed position of the container and the upper side of the single product plate or the distance between the container lid, in particular said first operating area, in the closed position of the container and the upper side of said upper product plate of said stack or the distance between the container lid, in particular said first operating area, in the closed position of the container and said second protective layer is smaller than said first deflection range or said first deflection maximum, in particular when the single product plate or the stack of product plates is resting on said container bottom or on said third protective layer, and/or
wherein the distance between the container bottom, in particular between said second operating area, in the closed position of the container and the bottom side of the single product plate or the distance between the container bottom, in particular said second operating area, in the closed position of the container and the bottom side of the lowest product plate of said stack or the distance between the container bottom, in particular said second operating area, in the closed position of the container and said third protective layer is smaller than said second deflection range or said second deflection maximum, in particular when the single product plate or the stack of product plates is resting on said container lid or on said second protective layer,
and/or wherein
the sum of the distance between the container bottom, in particular between said second operating area, in the closed position of the container and the bottom side of the single product plate or the distance between the container bottom, in particular said second operating area, in the closed position of the container and the bottom side of the lowest product plate of said stack or the distance between the container bottom, in particular said second operating area, in the closed position of the container and said third protective layer and the distance between the container lid, in particular said first operating area, in the closed position of the container and the upper side of the single product plate or the distance between the container lid, in particular said first operating area, in the closed position of the container and the upper side of said upper product plate of said stack or the distance between the container lid, in particular said first operating area, in the closed position of the container and said second protective layer is smaller than the sum of said first and second deflection ranges or of the sum of said first and second deflection maxima, so that upon deflecting said container lid, in particular said first operating area, in the direction of the interior of said container, in particular along its longitudinal axis, and/or that upon deflecting said container bottom, in particular said second operating area, in the direction of the interior of said container, in particular along its longitudinal axis, at least one product plate, in particular all product plates, are separable or separated into individual pieces along at least one, in particular essentially all of the weakening grooves.

2. Container according to claim 1, characterized in that the upper part of said container, in particular said container lid, and/or the lower part of said container, in particular said container bottom, comprises or is made of plastic and/or metal, in particular plastic and/or metal sheets.

3. Container according to claim 1 or 2, characterized in that said stack comprises at least two, three, four, five, six or seven, in particular edible, product plates, in particular chocolate bars.

4. Container according to any of the preceding claims, characterized in that at least two, in particular all, product plates are essentially identical in terms of length and/or width and/or diameter and/or thickness.

5. Container according to any of the preceding claims, characterized in that at least two, in particular all, product plates exhibit essentially identical weakening grooves with respect to cross-sectional shape and/or length and/or pattern of arrangement.

6. Container according to any of the preceding claims, characterized in that the product plate or plates exhibit an essentially polygonal, e.g. rectangular or square, basic form or a circular or oval basic form.

7. Container according to any of the preceding claims, characterized in that at least two, in particular all weakening grooves of a product plate have at least one crossing area, in particular in the center of the basic form of the product plates, or that all weakening grooves of a product plate cross each other in one, in particular central, crossing area of the basic form.

8. Container according to any of the preceding claims, characterized in that said first side wall and/or said first rim comprise or represent a first holding means and/or that said second side wall and/or said second rim comprise or represent a second holding means.

9. Container according to any of the preceding claims, characterized in that the upper part of the container closes the container in said first position and unblocks said container in said second position, wherein in said first position said first side wall and/or said first rim and/or said first holding means exhibits a form closure with said lower part of the container, in particular with said second side wall and/or said second rim and/or said second holding means,
that said upper part of the container can be transferred from said first to said second position upon a first deflection, in particular of said first operating area, in the direction of the interior of said container, in particular along its longitudinal axis, so that said form closure is, in particular reversibly, released,
and/or that the lower part of the container closes said container in a first position and unblocks said container in said second position, wherein in said first position said second side wall and/or said second rim and/or said second holding means exhibit a form closure with said upper part of the container, in particular with its first side wall and/or first rim and/or said first holding means, and
that said lower part of the container can be transferred from said first into said second position upon a second deflection, in particular of said second operating area, in the direction of the interior of said container, in particular along its longitudinal axis, so that the form closure is, in particular reversibly, released.

10. Container according to any of the preceding claims, characterized in that said first operating area represents or comprises the central part of the container lid and/or that said second operating area represents or comprises the central part of the bottom of the container.

11. Container according to any of the preceding claims, characterized in that upon deflecting said container lid, in particular said first operating area, in the direction of the interior of said container, in particular along its longitudinal axis, over said first deflection range, in particular up to said first deflection maximum,
or
that upon deflecting said container bottom, in particular said second operating area, in the direction of the interior of said container, in particular along its longitudinal axis, over said second deflection rang, in particular up to said second deflection maximum, or
that upon deflecting said container lid, in particular said first operating area, in the direction of the interior of said container, in particular along its longitudinal axis, over said first deflection range, in particular up to said first deflection maximum, and that upon deflecting said container bottom, in particular said second operating area, in the direction of the interior of said container, in particular along its longitudinal axis, over said second deflection rang, in particular up to said second deflection maximum,
at least one product plate, in particular all product plates, are separable or separated into individual pieces along at least one, in particular essentially all of the weakening grooves.

12. Container according to any of the preceding claims, characterized in that said first operating area has at least a partial overlap with the area in which the weakening grooves of one, several or all product plates cross each other, and/or that said second operating area has at least a partial overlap with the area in which the weakening grooves of one, several or all product plates cross each other.

13. Container according to claim 12, characterized in that the area in which the weakening grooves cross each other has at least a partial overlap with the center of the basic form of the product plate or plates.

14. Container according to any of claims 7 to 13, characterized in that the crossing areas, in particular when located in the central area of the basic form, of the weakening grooves of adjacent product plates, in particular of all product plates, in a stack are essentially arranged in an overlapping manner.

15. Container according to any of the preceding claims, characterized in that said at least one weakening groove, in particular all weakening grooves, of adjacent, in particular all, product plates in a stack are arranged essentially in overlapping manner.

16. Container according to any of the preceding claims, characterized in that the basic form of said container and the basic form of the product plates, in particular of said stack of product plates, is essentially identical.

17. Container according to claim 16, characterized in that the dimension of the basic form of said product plates, in particular the dimension of the stack of product plates, is, in particular slightly, smaller than the dimension of the basic form of the container.

18. Container according to any of the preceding claims, characterized in that said separable, individual pieces of the product plates exhibit a triangular basic shape or the shape of the segment of a circle.

19. Container according to any of the preceding claims, characterized in that the first and/or third protective layer represents or comprises a paper sheet and/or that said second and/or said third protective layer, in particular only said second protective layer, represents or comprises a padded or cushioned layer, in particular a paper padded layer.

20. Container according to any of claims 9 to 19, characterized in that upon applying pressure to said first side wall, said first rim and/or said first holding means on opposite sides thereof said first side wall and/or said first rim and/or said first holding means acquire a form closure with the lower part of the container, in particular with its second side wall and/or its second rim and/or its second holding means, thereby transferring the container from the open, second position into the closed, first position.

21. Container according to any of the preceding claims, characterized in that the dimension of the basic form of the container and the dimension of the basic form of the single product plate or stack of product plates provide a clearance so that upon deflection of the upper part, in particular of the container lid, and/or the lower part, in particular of the container bottom, lateral movement of the individual pieces split along their weakening groove or grooves is enabled.

22. Container according to any of the preceding claims, characterized in that the flanks of said weakening grooves are tilted and are forming on average an angle in the range of 5° to 60°, in particular in the range of 25° to 45°, and more particular in the range of 30° to 40°, and/or that the largest width of the weakening grooves is on average in the range of 3 to 9 mm, in particular in the range of 4 to 8 mm, and more preferred in the range of 6 to 7 mm, and/or that the depth of weakening grooves is on average in the range of 2 to 6 mm, in particular in the range of 2.5 to 5 mm, and more preferred in the range of 3 to 4 mm, and/or that the thickness of the product plates is on average in the range of 8 to 20 mm, in particular in the range of 8 to 14 mm, and more preferred in the range of 10.5 to 12 mm, and/or that the diameter of a circular product plate is in the range of 50 to 150 mm, in particular in the range of 60 to 120 mm, and more preferred in the range of 70 to 100 mm; and/or wherein the depth of weakening grooves is on average from 10 to 60%, in particular from 20 to 50%, and more preferred from 25 to 45%, of the thickness of the product plate.

23. Container according to any of the preceding claims characterized in that it comprises or represents a clic-clac box.

24. Use of the container according to any of the preceding claims, in particular according to any of claims 9 to 23, for splitting a single product plate or a multitude of product plates, in particular chocolate bars, comprising weakening grooves into individual pieces said product plate or plates being kept in said container during said splitting process.

25. Use, in particular according to claim 24, of a clic-clac box for splitting a single product plate or a multitude of product plates, in particular chocolate bars, comprising weakening grooves into individual pieces said product plate or plates being kept in said clic-clac box during said splitting process.

26. Use of claim 24 or 25, wherein said container or box comprises a multitude of product plates, in particular a multitude of chocolate bars, at least one containing at least one, in particular at least two weakening grooves, said multitude of product plates being arranged in a stack.

27. Process for the splitting of one or more product plates, in particular chocolate bars, into individual pieces along weakening grooves in said product plates comprising:
providing a container according to any of claims 1 to 23, for example a clic-clac box, placing a single product plate, in particular a chocolate bar, containing at least one, in particular at least two weakening grooves, or a multitude of product plates, in particular a multitude of chocolate bars, at least one containing at least one, in particular at least two weakening grooves, said multitude of product plates being arranged in a stack, in said container or box,
deflecting the upper part, in particular the lid, of said container or box, in particular in the first operating area, and/or deflecting the lower part, in particular the container bottom, of said container or box, in particular in said second operating area, in such a manner that said upper part of the container or box, in particular the container lid, is deflected in the direction of the interior of said container, in particular along its longitudinal axis, and/or in such a manner that the lower part of said container or box, in particular the container bottom of said container or box, is deflected in the direction of the interior of said container or box, in particular along its longitudinal axis, thereby splitting the product plates into individual pieces along said weakening grooves.

28. Process according to claim 27, characterized in that a product plate or product plates are provided in which at least two, in particular all weakening grooves of said product plate or plates have at least one crossing area, in particular in the center of the basic form of the product plate or plates, or that all weakening grooves of the product plate or plates cross each other in one, in particular central, crossing area of the basic form.

29. Process according to claim 27 or 28, characterized in that it is provided that said first operating area represents or comprises the central part of the container lid and/or that said second operating area represents or comprises the central part of the bottom of the container.

30. Process according to any of claims 27 to 29, characterized in that it is provided that said first deflection extends over said first deflection range, in particular up to said first deflection maximum, and/or that said second deflection extends over said second deflection range, in particular up to said second deflection maximum.

31. Process according to any of claims 27 to 30, characterized in that it is provided that said first operating area has at least a partial overlap with the area in which the weakening grooves of one, several or all product plates cross each other, and/or that said second operating area has at least a partial overlap with the area in which the weakening grooves of one, several or all product plates cross each other.

32. Process according to claim 31, characterized in that it is provided that the area in which the weakening grooves cross each other has at least a partial overlap with the center of the basic form of the product plate or plates.

33. Process according to any of claims 27 to 32, characterized in that
it is provided that the distance between the container lid, in particular said first operating area, in the closed position of the container and the upper side of the single product plate or the distance between the container lid, in particular said first operating area, in the closed position of the container and the upper side of said upper product plate of said stack or the distance between the container lid, in particular said first operating area, in the closed position of the container and said second protective layer is smaller than said first deflection range or said first deflection maximum, in particular when the single product plate or the stack of product plates is resting on said container bottom or on said third protective layer,
and/or
it is provided that the distance between the container bottom, in particular between said second operating area, in the closed position of the container and the bottom side of the single product plate or the distance between the container bottom, in particular said second operating area, in the closed position of the container and the bottom side of the lowest product plate of said stack or the distance between the container bottom, in particular said second operating area, in the closed position of the container and said third protective layer is smaller than said second deflection range or said second deflection maximum, in particular when the single product plate or the stack of product plates is resting on said container lid or on said second protective layer,
or
it is provided that the sum of the distance between the container bottom, in particular between said second operating area, in the closed position of the container and the bottom side of the single product plate or the distance between the container bottom, in particular said second operating area, in the closed position of the container and the bottom side of the lowest product plate of said stack or the distance between the container bottom, in particular said second operating area, in the closed position of the container and said third protective layer and the distance between the container lid, in particular said first operating area, in the closed position of the container and the upper side of the single product plate or the distance between the container lid, in particular said first operating area, in the closed position of the container and the upper side of said upper product plate of said stack or the distance between the container lid, in particular said first operating area, in the closed position of the container and said second protective layer is smaller than the sum of said first and second deflection ranges or of the sum of said first and second deflection maxima.

34. Process according to any of claims 27 to 33, characterized in that it is provided that upon deflecting said container lid, in particular said first operating area, in the direction of the interior of said container, in particular along its longitudinal axis, over said first deflection range, in particular up to said first deflection maximum,
or
that upon deflecting said container bottom, in particular said second operating area, in the direction of the interior of said container, in particular along its longitudinal axis, over said second deflection rang, in particular up to said second deflection maximum, or
that upon deflecting said container lid, in particular said first operating area, in the direction of the interior of said container, in particular along its longitudinal axis, over said first deflection range, in particular up to said first deflection maximum, and that upon deflecting said container bottom, in particular said second operating area, in the direction of the interior of said container, in particular along its longitudinal axis, over said second deflection rang, in particular up to said second deflection maximum,
at least one product plate, in particular all product plates, are separated into individual pieces along at least one, in particular essentially all of the weakening grooves.

35. Product plate, in particular chocolate bar, which can be split along weakening grooves into individual pieces, comprising a bottom side, an upper side and a rim, wherein said bottom side and/or said upper side comprise at least two weakening grooves which extend from a first position at or adjacent to the rim to a second position at or adjacent to said rim wherein said weakening grooves cross each other, in particular only once and/or in the central part of the product plate.

36. Product plate according to claim 35, characterized in that there is only one crossing area in which all weakening grooves cross each other.

37. Product plate according to claim 35 or 36, characterized in that the weakening grooves with regard to their cross-sectional shape extend on average over at least a third of the average thickness of the product plate.

38. Product plate according to any of claims 35 to 37, characterized in that said weakening grooves have a tapered cross-section from top to bottom.

39. Product plate according to any of claims 35 to 38, characterized in that said weakening grooves are essentially straight lined.

40. Product plate according to any of claims 35 to 39, characterized in that the basic form of said product plate is circular or oval or polygonal.

41. Product plate according to any of claims 35 to 40, characterized in that the flanks of said weakening grooves are tilted and are forming on average an angle the range of 5 to 60°.

42. Product plate according to any of claims 35 to 41, characterized in that the largest width of the weakening grooves is on average in the range of 3 to 9 mm, in particular in the range of 4 to 8 mm, and more preferred in the range of 6 to 7 mm, and/or that the depth of weakening grooves is on average in the range of 2 to 6 mm, in particular in the range of 2.5 to 5 mm, and more preferred in the range of 3 to 4 mm, and/or that the thickness of the product plates is on average in the range of 8 to 20 mm, in particular in the range of 8 to 14 mm, and more preferred in the range of 10.5 to 12 mm, and/or that the diameter of a circular product plate is in the range of 50 to 150 mm, in particular in the range of 60 to 120 mm, and more preferred in the range of 70 to 100 mm, and/or wherein the depth of weakening grooves is on average from 10 to 60%, in particular from 20 to 50%, and more preferred from 25 to 45%, of the thickness of the product plate.

43. Product plate according to any of claims 35 to 42, characterized in that the diameter or length of the crossing area of the weakening grooves is broader than the width of said weakening grooves.

44. Product plate according to any of claims 35 to 43, characterized in that at least one, in particular several or all separable individual pieces of said product plate formed by weakening grooves crossing each other have a smaller thickness adjacent to the crossing area than adjacent to the rim.

45. Product plate according to any of claims 35 to 44, characterized in that at least one, in particular all weakening grooves have a smaller depth adjacent to the crossing area than adjacent to the rim.

46. Stack of product plates comprising at least two product plates according to any of claims 35 to 45.
